(19) United States
(12) Patent Application Publication
(10) Pub. No.: US 2010/0319550 A1
(43) Pub. Date: Dec. 23, 2010

(54) GRILL OPENED IN TWO DIRECTIONS

(75) Inventor: Chunyu WU, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/648,472

(22) Filed: Dec. 29, 2009

(30) Foreign Application Priority Data
Jun. 17, 2009 (CN) 200920139121.9

(51) Int. Cl. A47J 37/06

(52) U.S. Cl. 99/380

(57) ABSTRACT

The present invention discloses a grill, comprising an upper shell, a lower shell and a hinge mechanism for controlling the relative position of the two shells; the hinge mechanism comprises a first hinge unit and a second hinge unit; the first hinge unit comprises a rotating shaft, and the rotating shaft comprises a horizontal shaft connected to the upper shell and a vertical shaft connected to the lower shell; the second hinge unit comprises a fixed hinge part on the lower shell and a detachable hinge part on the upper shell, and the detachable hinge part is removablly hinged to the fixed hinge part. Compared to the conventional technique, the upper shell and the lower shell could be easily arranged side by side when they are opened to 180°, and the upper grill pan and the lower grill pan are near to the user so that the grill is easy to operate and is designed humanized.

### FIELD OF THE INVENTION

The present invention relates to a grill, especially relates to a grill that its upper shell and lower shell could be opened in two directions and the opening angle could be controlled.

### BACKGROUND OF THE INVENTION

In the conventional technique, the grill having function of two-sided baking comprises an upper shell, a lower shell, an upper grill pan embedded in the upper shell and a lower grill pan embedded in the lower shell, when it is working, the upper shell and the lower shell could be in the positions where they could form angles of 105° and 180°, so that the grill is easy to operate.

An invention published in Chinese patent application No. CN201150466Y, comprises a pedestal, an upper shell, an upper grill pan under the upper shell and a lower grill pan on the pedestal, and in the invention, the structure made up of a sleeve, a sliding block, a spring and a button could achieve that the two grill pan could be opened to 105° and 180°.

Another invention published in Chinese patent application No. CN201160788Y is grill having two opening conditions which comprises an upper shell, a lower shell, an upper grill pan and a lower grill pan. The rears of the two shells are hinged to each other, and the two grill pans are respectively embedded in the opposite surfaces of the two shells. In the patent, the device of regulating angle could locate the two grill pans in the positions where they could form angles of 105° and 180°.

All the conventional grills including the above grills, when the upper grill pan and the lower grill pan are opened and form an angle of 180°, they are opened relatively, and the rears of the two grill pans are connected together. So the two grill pans could not be arranged side by side. Owing to the electric system laid out in the front of the lower grill pan or in the anterolateral part of it, one of the two parallel bakewaes is certain far from the user, so it is inconvenient for user to operate the grill. Because the rears of the two grill pans are connected together, oil storage boxes should be put before the two grill pans, if the angled device of oil spills is preserved.

### SUMMARY OF THE INVENTION

The main purpose of the invention is to overcome the shortage that when the grill is opened to 180°, the upper grill pan and the lower grill pan are connected only by the way of hinging their rears together. The present invention provides a grill in which the rears of the upper grill pan and the lower grill pan could be separated and the two grill pans could be in side by side position, the two grill pans are opened to 180°.

The technical solution applied by the present invention is:

A grill opened in two directions comprises an upper shell provided with an upper grill pan, a lower shell provided with a lower grill pan and a hinge mechanism used for connecting the upper shell and the lower shell and controlling the relative positions of the two shells; wherein the hinge mechanism comprises a first hinge unit and a second hinge unit, respectively disposed on the two ends of the connecting sides of the two shells; wherein the first hinge unit comprises a rotating shaft which comprises a horizontal shaft and vertical shaft, which are respectively hinged to the lower shell and the upper shell; wherein the second hinge unit comprises a fixed hinge part on the lower shell and a detachable hinge part on the upper shell, and the detachable hinge part is hinged to the fixed hinge part removablly.

In a preferred embodiment of the present invention, said rotating shaft is in the shape of

[symbol]

In a preferred embodiment of the present invention, said first hinge unit also comprises a first hinge and a pendulum rod; wherein the first hinge is fixed to said lower shell, and a first articulated tube matching said horizontal shaft is set up on the first hinge; wherein the pendulum rod is fixed to said upper shell, and a second articulated tube matching said vertical shaft is set up on the second hinge.

Furthermore, the horizontal shaft has a limit convex column, and said first hinge has a limit stopper; when said upper shell is opened relative to the lower shell so as to make the limit convex column press against the limit stopper, the upper shell and the lower shell form an angle of 105°.

In a preferred embodiment of the present invention, said fixed hinge part comprises a second hinge which has a spring and a button, and the button comprises a press part, a rectangular plate and a cylindrical part which are arranged in turn; wherein said detachable hinge part comprises a ring which has a rectangular opening dovetailed with the rectangular plate, when the button is pressed.

Moreover, the thickness of said rectangular plate is no deeper than the width of said rectangular opening.

Moreover, the length of said rectangular plate is no longer than the length of said rectangular opening.

The grill opened in two directions in the present invention is working in the way of double-sided grill, the horizontal shaft is hinged to the first articulated tube, and the ring of the detachable hinge part is hinged to the cylindrical part of the button so as to make the upper shell and the lower shell assembled together. When the upper shell is lifted to make the limit convex column press against limit stopper, the upper shell and the lower shell steadily form an angle of 105°. If the two grill pans are needed to be used for single-sided baking simultaneously, the button should be pressed to make the rectangular plate of the button pass through the rectangular opening of the ring so that the detachable hinge part and the fixed hinge part are separated from each other, and then the upper shell rotate relative to the vertical shaft of the rotating shaft so that the upper shell and the lower shell form an angle of 180° and are arranged side by side.

From the above descriptions of the present invention, compared to the conventional technique, with a [symbol] shaped rotating shaft, a detachable hinge part and a fixed hinge part, the grill opened in two directions of the present invention could be easily opened to 180° to make the upper shell and the lower shell arranged side by side, and the two grill pans are near to the user so that the grill could be operated conveniently. Besides, because the rears of the two shells are separated from each other, if the angled device of oil spills is preserved, only a oil storage box is laid out in order to facilitating oil spills and operation of the grill. So the grill is designed very humanized.

### BRIEF DESCRIPTION OF THE DRAWINGS

FIG. 1 is a three-dimension view of the grill opened in two directions when it is closed in a preferred embodiment.

FIG. 2 is a three-dimension view of the grill opened in two directions when it is opened to 105° in a preferred embodiment.

FIG. 3 is a three-dimension view of the grill opened in two directions when it is opened to 180° in a preferred embodiment.

FIG. 4 is a schematic diagram of assembly of the first hinge unit of the grill opened in two directions in a preferred embodiment.

FIG. 5 is a three-dimension exploded view of the first hinge unit of the grill opened in two directions in a preferred embodiment.

FIG. 6 is a schematic diagram of assembly of the second hinge unit of the grill opened in two directions in a preferred embodiment.

FIG. 7 is a three-dimension exploded view of the second hinge unit of the grill opened in two directions in a preferred embodiment.

### DESCRIPTIONS OF SPECIFIC EMBODIMENTS

The present invention will become apparent upon the reference of the detailed embodiment.

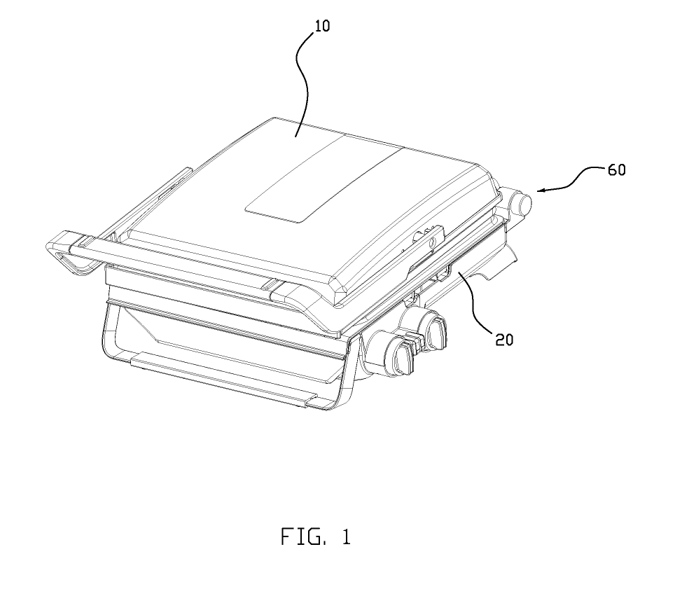

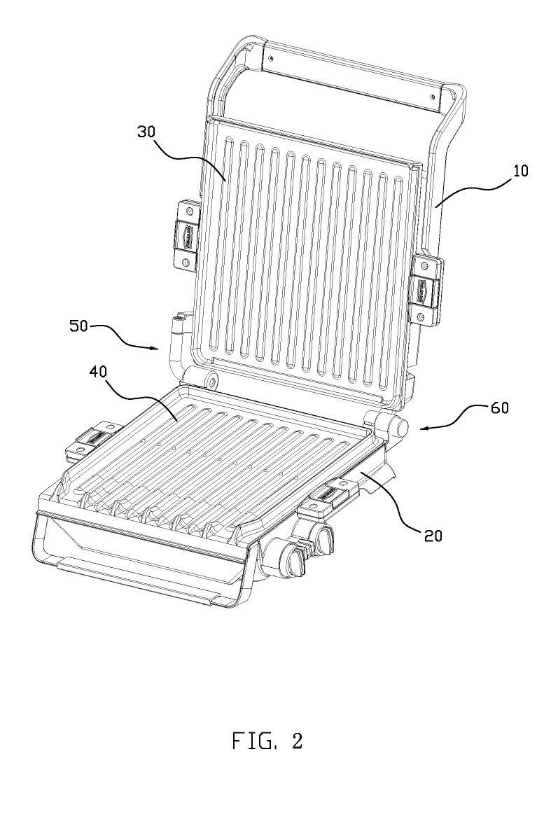

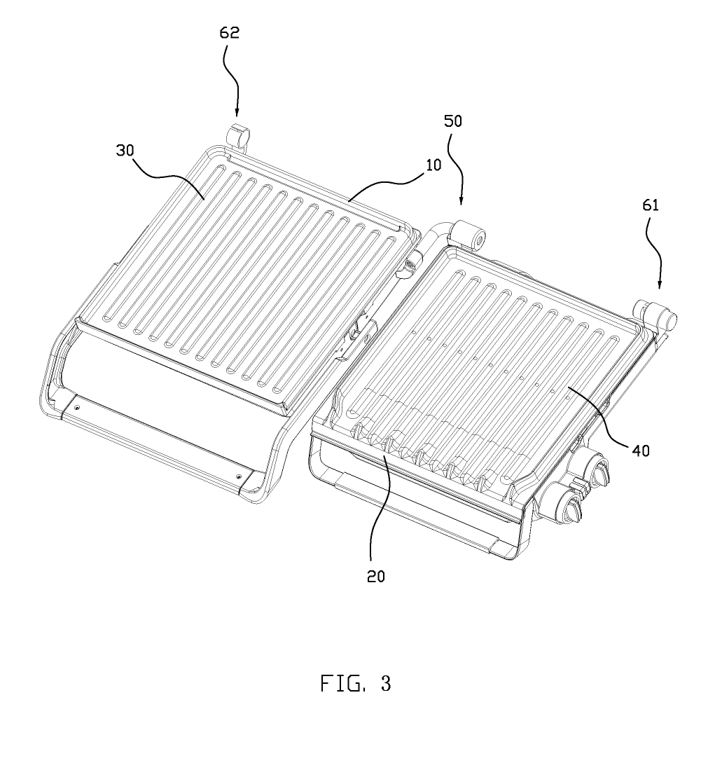

Referring to FIGS. 1 to 3, a grill opened in two directions comprises an upper shell 10 provided with an upper grill pan 30, a lower shell 20 provided with a lower grill pan 40 and a hinge mechanism used for connecting the upper shell and the lower shell, and controlling the relative position of the two shells; wherein the hinge mechanism comprises a first hinge unit 50 and a second hinge unit 60, respectively disposed on the two ends of the connecting sides of the two shells.

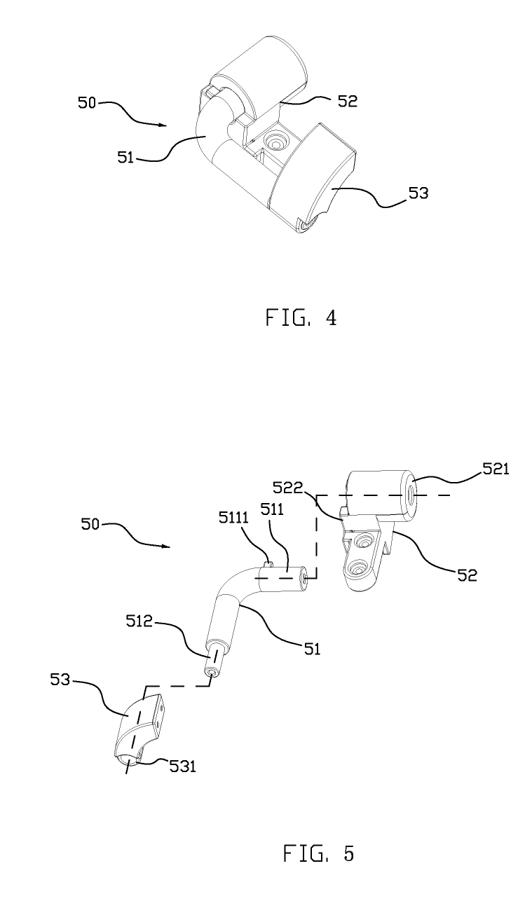

Referring to FIG. 4 and FIG. 5, the first hinge unit 50 comprises a [symbol] shaped rotating shaft 51, a first hinge 52, and a pendulum rod 53. The first hinge 52 is fixed to the lower shell 20, and a first articulated tube 521 matching the horizontal shaft 511 is fixed to the first hinge 52; the pendulum rod 53 is fixed to the upper shell 10, and a second articulated tube 531 matching the vertical shaft 512 of the [symbol] shaped rotating shaft 51 is fixed to the first hinge 52.

The horizontal shaft 511 has a limit convex column 5 111, and the first hinge 52 has a limit stopper 522. When the upper shell 10 is opened relative to the lower shell 20 to make the limit convex column 5111 press against the limit stopper 522, the two shells form an angle of 105°.

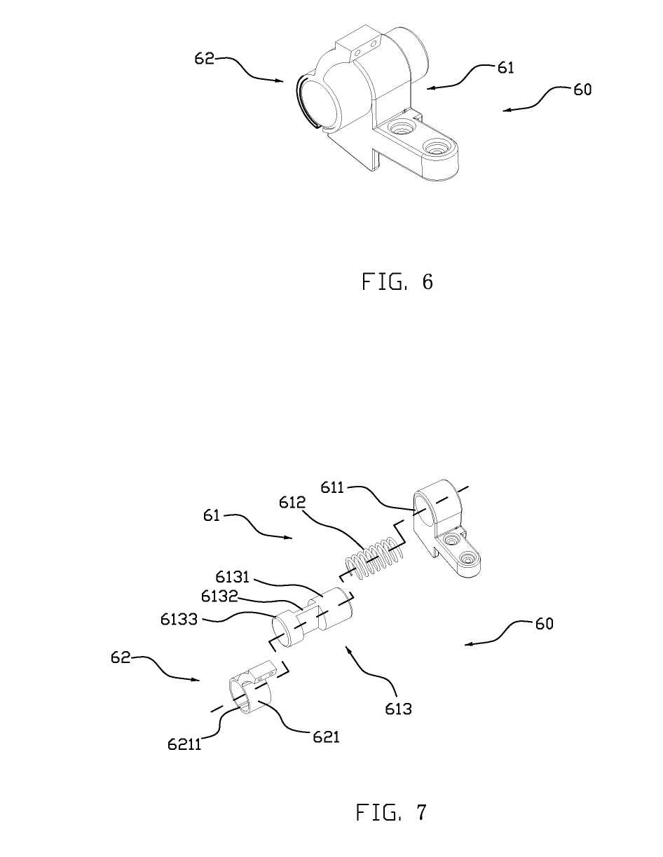

Referring to FIG. 6 and FIG. 7, the second hinge unit 60 comprises a fixed hinge part 61 on the lower shell 20 and a detachable hinge part 62, and the detachable hinge part 62 is hinged to the fixed hinge part 61 removablly.

The fixed hinge part 61 comprises a second hinge 611 which has a spring 612 and button 613, and the button 613 comprises a press part 6131, a rectangular plate 6132 and a cylindrical part 6133 which are all arranged in turn; the detachable hinge part 62 comprises a ring 621 which has a rectangular opening 6211, and when the button 613 is pressed to move, the rectangular opening 6211 is dovetailed with the rectangular plate 6132 of the button 613. Besides, the thickness of the rectangular plate 6132 is no deeper than the width of the rectangular opening 6211 and the length of the rectangular plate 6132 is no longer than the length of the rectangular opening 6211, so that when the button 613 is pressed, the rectangular plate 6132 could pass through the rectangular opening 6211 and the detachable hinge part 62 are separated from the fixed hinge part 61.

The grill opened in two directions in the present invention is working in the way of double-sided grill, the horizontal shaft 511 is hinged to the first articulated tube 521, and the ring 621 of the detachable hinge part 62 is hinged to the cylindrical part 6133 of the button 613 so as to make the upper shell 10 and the lower shell 20 assembled together. When the upper shell 10 is lifted to make the limit convex column 5111 press against limit stopper 522, the upper shell 10 and the lower shell 20 steadily form an angle of 105°. If the two grill pans are needed to be used for single-sided baking simultaneously, the button 613 should be pressed to make the rectangular plate 6132 of the button 613 pass through the rectangular opening 6211 of the ring 621 so that the detachable hinge part 62 and the fixed hinge part 61 are separated from each other, and then with the second articulated tube 531, the upper shell 10 could rotate relative to the vertical shaft 512 of the [symbol] shaped rotating shaft 51 so that the upper shell 10 and the lower shell 20 form an angle of 180° and are arranged side by side.

All above is just a preferred embodiment of the present invention, and the present is not limited in it. All the unessential modifications and alternations of the present invention will be apparent in the scope of the present invention.

What is claimed is:

1. A grill opened in two directions comprises an upper shell provided with an upper grill pan; a lower shell provided with a lower grill pan; and a hinge mechanism used for connecting said upper shell and said lower shell, and controlling the relative positions of the two shells, wherein said hinge mechanism comprises a first hinge unit and a second hinge unit, which are respectively disposed on the two ends of the connecting sides of the two shells; wherein said first hinge unit comprises a rotating shaft which comprises a horizontal shaft and vertical shaft respectively hinged to the lower shell and the upper shell; wherein said second hinge unit comprises a fixed hinge part on the lower shell and a detachable hinge part on the upper shell, and the detachable hinge part is hinged to the fixed hinge part removablly.

2. The grill opened in two directions according to claim 1, wherein said rotating shaft is in the shape of

[symbol]

3. The grill opened in two directions according to claim 1, wherein said first hinge unit also comprises a first hinge and a pendulum rod; wherein said first hinge is fixed to said lower shell, and a first articulated tube matching said horizontal shaft is set up on the first hinge; wherein said pendulum rod is fixed to said upper shell, and a second articulated tube matching said vertical shaft is set up on the second hinge.

4. The grill opened in two directions according to claim 3, wherein said horizontal shaft has a limit convex column, and said first hinge has a limit stopper; when said upper shell is opened relative to the lower shell so as to make the limit convex column press against the limit stopper, the upper shell and the lower shell form an angle of 105°.

5. The grill opened in two directions according to claim 1, wherein said fixed hinge part comprises a second hinge which has a spring and a button provided with a press part, a rectangular plate and a cylindrical part; wherein said detachable hinge part comprises a ring which has a rectangular opening dovetailed with the rectangular plate when said button is pressed.

6. The grill opened in two directions according to claim 5, wherein the thickness of said rectangular plate is no deeper than the width of said rectangular opening.

7. The grill opened in two directions according to claim 5, wherein the length of said rectangular plate is no longer than the length of said rectangular opening.
